(19) United States
(12) Patent Application Publication
(10) Pub. No.: US 2026/0228608 A1
(43) Pub. Date: Aug. 6, 2026

(54) SYSTEM AND METHOD FOR AUDITING AND ENFORCING CONDITIONAL FAIRNESS VIA OPTIMAL TRANSPORT

(71) Applicant: JPMorgan Chase Bank, N.A., New York, NY (US)

(72) Inventors: Mohsen GHASSEMI, Jersey City, NJ (US); Alan MISHLER, Pittsburgh, PA (US); Niccolo DALMASSO, Long Island City, NY (US); Vamsi Krishna POTLURU, New York, NY (US); Manuela VELOSO, New York, NY (US)

(73) Assignee: JPMorgan Chase Bank, N.A., New York, NY (US)

(21) Appl. No.: 19/044,985

(22) Filed: Feb. 4, 2025

(51) Int. Cl. G06N 20/00

(52) U.S. Cl. CPC G06N 20/00

(57) ABSTRACT

Various methods and processes, apparatuses/systems, and media for auditing and enforcing conditional fairness in a machine learning model (MLM) are disclosed. A processor identifies features associated with the model; determines a first joint distribution of model outputs and a feature based on a first level of a particular one of the features and a second joint distribution of model outputs and a feature based on a second level of the particular feature; calculates corresponding conditional demographic disparity (CDD) between the first joint distribution and the second joint distribution at both levels; aggregates each CDD into a single CDD value; audits the conditional fairness by computing a distance between the first joint distribution and the second joint distribution based on the single CDD value; computes, based on the distance, a regularizer that reduces the CDD; and enforces the conditional fairness by applying the regularizer to the MLM.

### TECHNICAL FIELD

This disclosure generally relates to data processing, and, more particularly, to methods and apparatuses for implementing a platform, language, cloud, and database agnostic conditional fairness auditing and enforcing module configured to audit and enforce conditional fairness via optimal transport.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Algorithmic decision-making may prove to be having an increasing impact on individuals' lives, in areas such as finance, healthcare, and hiring. The growing field of algorithmic fairness typically aims to define, measure, and prevent discrimination in such systems. For example, work in algorithmic group-fairness assumes that decisions by a data-driven model ought to be invariant to the group membership of individuals for some protected and/or sensitive feature(s) of interest, such as race, gender, national origin, or disability status. There appears to be many ways of quantifying this invariance; each such quantification constitutes a particular fairness measure. The violation of a particular fairness measure is typically referred to as the group disparity of a model, relative to that measure. This general premise has yielded fairness-aware artificial intelligence in many specialized applications and under several fairness measures.

Among the myriad of fairness definitions in the literature, many are mutually unsatisfiable in practice. Demographic parity (DP; also referred to herein as “statistical parity”) requires marginal independence between a sensitive feature and an algorithm output. Although this is a widely discussed fairness definition, it is coarse enough that it may mask intuitively unfair behavior.

DP may fail to capture intuitive notions of fairness and unfairness in the presence of data exhibiting Simpson's paradox, i.e., where a correlation exists on subsets of data but is not present or reverses sign when the subsets are combined. For example, in one gender bias study, it is shown that there was an appearance of an admission bias against women, who applied to more selective departments at a university. However, within each department, women were selected at similar rates as male applicants. Over time, decision systems which satisfy demographic parity can even lead to worse outcomes for a particular group, or greater disparities between different groups.

Conditional demographic parity (CDP) is a measure of the demographic parity of a predictive model or decision process when conditioning on an additional feature or set of features. CDP may require independence of the output and the sensitive feature conditional on a legitimate or explanatory feature or set of features, such as income in a loan application. One way to achieve CDP may be to use only the legitimate features as model inputs, but this may result in unacceptably poor predictive performance. When the legitimate features have a small number of levels, CDP may also be satisfied by maintaining a separate model for each subgroup defined by values of the legitimate feature and applying a method that targets DP to each subgroup. However, this approach may be infeasible when the legitimate feature has many levels. Many algorithmic fairness techniques exist to target demographic parity, but CDP may prove to be much harder to achieve, particularly when the conditioning variable has many levels and/or when the model outputs are continuous.

### SUMMARY

The present disclosure, through one or more of its various aspects, embodiments, and/or specific features or sub-components, provides, among other features, various systems, servers, devices, methods, media, programs, and platforms for implementing a platform, language, cloud, and database agnostic conditional fairness auditing and enforcing module configured to implement artificial intelligence and machine learning models and techniques to audit and enforce conditional fairness via optimal transport regardless of whether conditioning variable has many levels and validate efficacy of the implemented algorithms on real-world datasets, but the disclosure is not limited thereto.

In some embodiments, a method for auditing and enforcing conditional fairness in a machine learning model by utilizing one or more processors along with allocated memory is disclosed. The method may include: identifying at least one feature associated with data that is inputted into the machine learning model; determining a first joint distribution of outputs from the machine learning model and a second feature from among the at least one feature based on a first level of a first feature from among the at least one feature and a second joint distribution of outputs from the machine learning model and the second feature based on a second level of the first feature; calculating corresponding conditional demographic disparity between the first joint distribution and the second joint distribution with respect to both the first feature and the second feature and with respect to both the first level and the second level; aggregating each conditional demographic disparity into a single conditional demographic disparity value; auditing the conditional fairness by computing a distance between the first joint distribution and the second joint distribution based on the single conditional demographic disparity value; computing, based on the distance, a regularizer that reduces the conditional demographic disparity; and enforcing the conditional fairness by applying the regularizer to the machine learning model, thereby substantially improving performance of the machine learning model in outputting results.

In some embodiments, in enforcing the conditional fairness, the method may further include: computing a weighted average value of the calculated corresponding conditional demographic disparity.

In some embodiments, the machine learning model may be configured to use an artificial intelligence technique for making a decision based on input data that relates to a person, and wherein the decision relates to at least one from among a consumer finance question, a health insurance question, and a hiring question, but the disclosure is not limited thereto.

In some embodiments, the first feature may include at least one from among race, gender, national origin, and disability, but the disclosure is not limited thereto.

In some embodiments, the second feature may include one from among a level of education, a grade point average, and a level of income, but the disclosure is not limited thereto.

In some embodiments, the machine learning model may include one or more of the following models: decision tree, ensemble trees, logistic regression, neural network architectures, and predictive model, but the disclosure is not limited thereto.

In some embodiments, a system for auditing and enforcing conditional fairness in a machine learning model is disclosed. The system may include: a processor; and a memory operatively connected to the processor via a communication interface, the memory storing computer readable instructions, when executed, may cause the processor to: identify at least one feature associated with data that is inputted into the machine learning model; determine a first joint distribution of outputs from the machine learning model and a second feature from among the at least one feature based on a first level of a first feature from among the at least one feature and a second joint distribution of outputs from the machine learning model and the second feature based on a second level of the first feature; calculate corresponding conditional demographic disparity between the first joint distribution and the second joint distribution with respect to both the first feature and the second feature and with respect to both the first level and the second level; aggregate each conditional demographic disparity into a single conditional demographic disparity value; audit the conditional fairness by computing a distance between the first joint distribution and the second joint distribution based on the single conditional demographic disparity value; compute, based on the distance, a regularizer that reduces the conditional demographic disparity; and enforce the conditional fairness by applying the regularizer to the machine learning model, thereby substantially improving performance of the machine learning model in outputting results.

In some embodiments, in enforcing the conditional fairness, the processor may be further configured to: compute a weighted average value of the calculated corresponding conditional demographic disparity.

In some embodiments according to the system, the machine learning model may be configured to use an artificial intelligence technique for making a decision based on input data that relates to a person, and wherein the decision relates to at least one from among a consumer finance question, a health insurance question, and a hiring question, but the disclosure is not limited thereto.

In some embodiments according to the system, the first feature may include at least one from among race, gender, national origin, and disability, but the disclosure is not limited thereto.

In some embodiments according to the system, the second feature may include one from among a level of education, a grade point average, and a level of income, but the disclosure is not limited thereto.

In some embodiments according to the system, the machine learning model may include one or more of the following models: decision tree, ensemble trees, logistic regression, neural network architectures, and predictive model, but the disclosure is not limited thereto.

In some embodiments, a non-transitory computer readable medium configured to store instructions for auditing and enforcing conditional fairness in a machine learning model is disclosed. The instructions, when executed, may cause a processor to perform the following: identifying at least one feature associated with data that is inputted into the machine learning model; determining a first joint distribution of outputs from the machine learning model and a second feature from among the at least one feature based on a first level of a first feature from among the at least one feature and a second joint distribution of outputs from the machine learning model and the second feature based on a second level of the first feature; calculating corresponding conditional demographic disparity between the first joint distribution and the second joint distribution with respect to both the first feature and the second feature and with respect to both the first level and the second level; aggregating each conditional demographic disparity into a single conditional demographic disparity value; auditing the conditional fairness by computing a distance between the first joint distribution and the second joint distribution based on the single conditional demographic disparity value; computing, based on the distance, a regularizer that reduces the conditional demographic disparity; and enforcing the conditional fairness by applying the regularizer to the machine learning model, thereby substantially improving performance of the machine learning model in outputting results.

In some embodiments, in enforcing the conditional fairness, the instructions, when executed, may cause the processor to further perform the following: computing a weighted average value of the calculated corresponding conditional demographic disparity.

In some embodiments according to the non-transitory computer readable medium, the machine learning model may be configured to use an artificial intelligence technique for making a decision based on input data that relates to a person, and wherein the decision relates to at least one from among a consumer finance question, a health insurance question, and a hiring question, but the disclosure is not limited thereto.

In some embodiments according to the non-transitory computer readable medium, the first feature may include at least one from among race, gender, national origin, and disability, but the disclosure is not limited thereto.

In some embodiments according to the non-transitory computer readable medium, the second feature may include one from among a level of education, a grade point average, and a level of income, but the disclosure is not limited thereto.

In some embodiments according to the non-transitory computer readable medium, the machine learning model may include one or more of the following models: decision tree, ensemble trees, logistic regression, neural network architectures, and predictive model, but the disclosure is not limited thereto.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, language, database, and cloud agnostic conditional fairness auditing and enforcing module configured to implement artificial intelligence and machine learning models and techniques to audit and enforce conditional fairness via optimal transport in accordance with an embodiment.

FIG. 2 illustrates a diagram of a network environment with a platform, language, database, and cloud agnostic conditional fairness auditing and enforcing device in accordance with an embodiment.

FIG. 3 illustrates a system diagram for implementing a platform, language, database, and cloud agnostic conditional fairness auditing and enforcing device having a platform, language, database, and cloud agnostic conditional fairness auditing and enforcing module in accordance with an embodiment.

FIG. 4 illustrates a system diagram for implementing a platform, language, database, and cloud agnostic conditional fairness auditing and enforcing module of FIG. 3 in accordance with an embodiment.

FIG. 5 illustrates an algorithm implemented by the platform, language, database, and cloud agnostic conditional fairness auditing and enforcing module of FIG. 4 for auditing and enforcing conditional fairness in accordance with an embodiment.

FIG. 6 illustrates a flow chart of a process implemented by the platform, language, database, and cloud agnostic conditional fairness auditing and enforcing module of FIG. 4 for implementing artificial intelligence and machine learning models and techniques to audit and enforce conditional fairness via optimal transport in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in may include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

As mentioned earlier, among the myriad of fairness definitions in the literature, many are mutually unsatisfiable in practice. For example, DP may fail to capture intuitive notions of fairness and unfairness in the presence of data exhibiting Simpson's paradox, i.e., where a correlation exists on subsets of data but is not present or reverses sign when the subsets are combined. For example, in one gender bias study, it is shown that there was an appearance of an admission bias against women, who applied to more selective departments at a university. However, within each department, women were selected at similar rates as male applicants. Over time, decision systems which satisfy demographic parity can even lead to worse outcomes for a particular group, or greater disparities between different groups.

CDP, as mentioned earlier, is a measure of the demographic parity of a predictive model or decision process when conditioning on an additional feature or set of features. CDP may require independence of the output and the sensitive feature conditional on a legitimate or explanatory feature or set of features, such as income in a loan application. One way to achieve CDP may be to use only the legitimate features as model inputs, but this may result in unacceptably poor predictive performance. When the legitimate features have a small number of levels, CDP may also be satisfied by maintaining a separate model for each subgroup defined by values of the legitimate feature and applying a method that targets DP to each subgroup. However, this approach may also be infeasible when the legitimate feature has many levels. Many algorithmic fairness techniques exist to target demographic parity, but CDP may prove to be much harder to achieve, particularly when the conditioning variable has many levels and/or when the model outputs are continuous.

Moreover, as mentioned earlier, conventional technique fails to implement algorithms that directly target the distances between the relevant conditional distributions. Additionally, conventional techniques may require access to the sensitive feature at inference time, which may further result in unacceptably poor predictive model performance and fail to ensure equality of conditional output distributions across levels of the legitimate feature, regardless of whether the output is discrete or continuous. For example, when model outputs are continuous, conventional techniques fail to target full equality of the conditional distributions, and only consider first moments or related proxy quantities, thereby generating poor output with respect to CDP.

The present disclosure, through one or more of its various aspects, embodiments, and/or specific features or sub-components, provides, among other features, various systems, servers, devices, methods, media, programs, and platforms for implementing a platform, language, cloud, and database agnostic conditional fairness auditing and enforcing module configured to implement artificial intelligence and machine learning models and techniques to audit and enforce conditional fairness via optimal transport regardless of whether conditioning variable has many levels and validate efficacy of the implemented algorithms on real-world datasets and do not require access to the sensitive feature at inference time, thereby greatly improving accuracy of model output, but the disclosure is not limited thereto. Moreover, the conditional fairness auditing and enforcing module may be configured to measure conditional demographic disparity (CDD) which relies on statistical distances from the optimal transport, i.e., Wasserstein distances, and aggregate the level-wise disparities to obtain a single CDD value, thereby further improving accuracy of model output, but the disclosure is not limited thereto.

Although the processes as disclosed herein utilized loan or credit card application, the processes as disclosed herein may be utilized in other use cases, such as managing, matching, and sourcing employment candidates in a recruitment campaign, making a decision on carrier improvement, making a decision on administering doses of medicine for a treatment plan for a patient, making a decision on admitting a patient, admission process to an educational institution, etc., but the disclosure is not limited thereto.

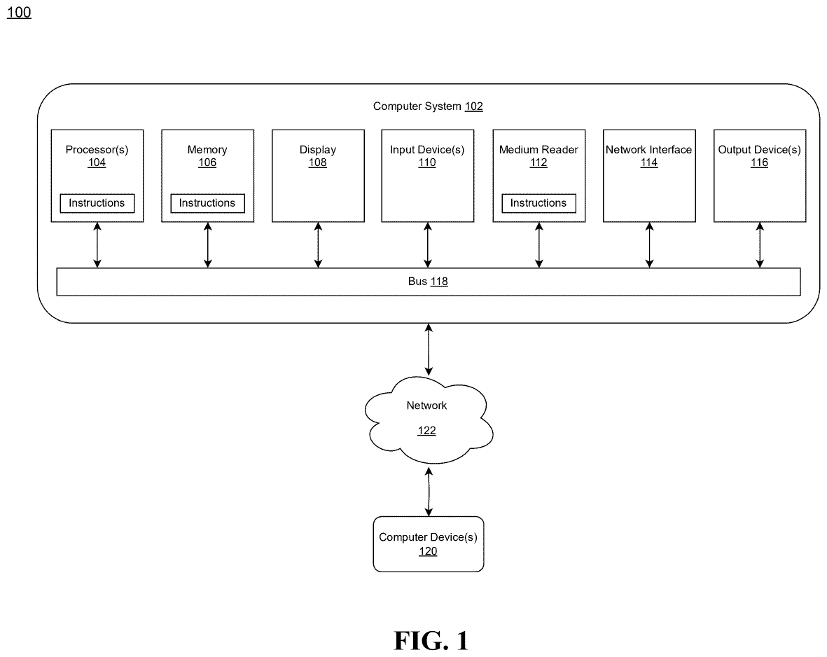

FIG. 1 is an exemplary system 100 for use in implementing a platform, language, database, and cloud agnostic conditional fairness auditing and enforcing module configured to implement artificial intelligence and machine learning models and techniques to audit and enforce conditional fairness via optimal transport regardless of whether conditioning variable has many levels and validate efficacy of the implemented algorithms on real-world datasets in accordance with an exemplary embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. In some embodiments, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 may be tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, in some embodiments, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. In some embodiments, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the conditional fairness auditing and enforcing module may be platform, language, database, and cloud agnostic that may allow for consistent easy orchestration and passing of data through various components to output a desired result regardless of platform, browser, language, database, and cloud environment. Since the disclosed process, in some embodiments, may be platform, language, database, browser, and cloud agnostic, the conditional fairness auditing and enforcing module may be independently tuned or modified for optimal performance without affecting the configuration or data files. The configuration or data files, in some embodiments, may be written using JSON, but the disclosure is not limited thereto. In some embodiments, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations may include distributed processing, component/object distributed processing, and an operation mode having parallel processing capabilities. Virtual computer system processing may be constructed to implement one or more of the methods or functionality as described herein, and a processor described herein may be used to support a virtual processing environment.

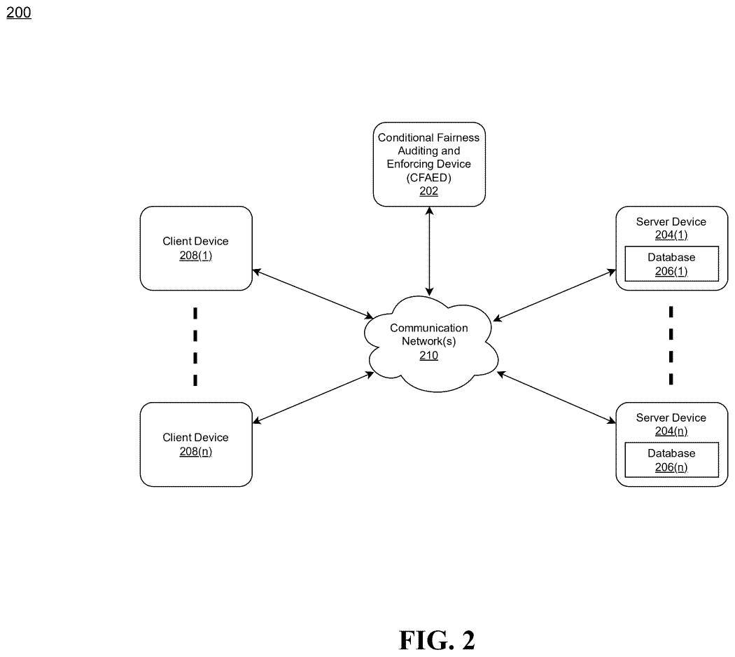

Referring to FIG. 2, a schematic of an exemplary network environment 200 for implementing a language, platform, database, and cloud agnostic conditional fairness auditing and enforcing device (CFAED) of the instant disclosure is illustrated.

In some embodiments, the above-described problems associated with conventional tools may be overcome by implementing an CFAED 202 as illustrated in FIG. 2 that may be configured for implementing a platform, language, database, and cloud agnostic conditional fairness auditing and enforcing module configured to implement artificial intelligence and machine learning models and techniques to audit and enforce conditional fairness via optimal transport regardless of whether conditioning variable has many levels and validate efficacy of the implemented algorithms on real-world datasets, but the disclosure is not limited thereto.

The CFAED 202 may have one or more computer system 102s, as described with respect to FIG. 1, which in aggregate provide the necessary functions.

The CFAED 202 may store one or more applications that may include executable instructions that, when executed by the CFAED 202, cause the CFAED 202 to perform actions, such as to transmit, receive, or otherwise process network messages, in some embodiments, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the CFAED 202 itself, may be located in virtual server(s) running in a cloud-based computing environment rather than being tied to one or more specific physical network computing devices. Also, the application(s) may be running in one or more virtual machines (VMs) executing on the CFAED 202. Additionally, in one or more embodiments of this technology, virtual machine(s) running on the CFAED 202 may be managed or supervised by a hypervisor.

In the network environment 200 of FIG. 2, the CFAED 202 may be coupled to a plurality of server devices 204(1)-204(n) that hosts a plurality of databases 206(1)-206(n), and also to a plurality of client devices 208(1)-208(n) via communication network(s) 210. A communication interface of the CFAED 202, such as the network interface 114 of the computer system 102 of FIG. 1, operatively couples and communicates between the CFAED 202, the server devices 204(1)-204(n), and/or the client devices 208(1)-208(n), which may all be coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the CFAED 202, the server devices 204(1)-204(n), and/or the client devices 208(1)-208(n) may be coupled together via other topologies. Additionally, the network environment 200 may include other network devices such as one or more routers and/or switches, in some embodiments, which are well known in the art and thus will not be described herein.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, in some embodiments, teletraffic in any suitable form (e.g., voice, modem, and the like), Public Switched Telephone Network (PSTNs), Ethernet-based Packet Data Networks (PDNs), combinations thereof, and the like.

The CFAED 202 may be a standalone device or integrated with one or more other devices or apparatuses, such as one or more of the server devices 204(1)-204(n). In some embodiments, the CFAED 202 may be hosted by one of the server devices 204(1)-204(n), and other arrangements may also be possible. Moreover, one or more of the devices of the CFAED 202 may be in the same or a different communication network including one or more public, private, or cloud networks, in some embodiments.

The plurality of server devices 204(1)-204(n) may be the same or similar to the computer system 102 or the computer device 120 as described with respect to FIG. 1, including any features or combination of features described with respect thereto. In some embodiments, any of the server devices 204(1)-204(n) may include, among other features, one or more processors, a memory, and a communication interface, which may be coupled together by a bus or other communication link, although other numbers and/or types of network devices may be used. The server devices 204(1)-204(n) in this example may process requests received from the CFAED 202 via the communication network(s) 210 according to the HTTP-based and/or JavaScript Object Notation (JSON) protocol, in some embodiments, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that may be configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

In some embodiments, the server devices 204(1)-204(n) may operate as a plurality of network computing devices within a cluster architecture, a peer-to peer architecture, virtual machines, or within a cloud architecture. Thus, the technology disclosed herein is not to be construed as being limited to a single environment and other configurations and architectures may also be envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that may facilitate the implementation of the CFAED 202 that may efficiently provide a platform for implementing a platform, language, database, and cloud agnostic conditional fairness auditing and enforcing module configured to implement artificial intelligence and machine learning models and techniques to audit and enforce conditional fairness via optimal transport regardless of whether conditioning variable has many levels and validate efficacy of the implemented algorithms on real-world datasets, but the disclosure is not limited thereto.

The client devices 208(1)-208(n) may run interface applications, such as standard web browsers or standalone client applications, which may provide an interface to communicate with the CFAED 202 via the communication network(s) 210 in order to communicate user requests. The client devices 208(1)-208(n) may further include, among other features, a display device, such as a display screen or touchscreen, and/or an input device, such as a keyboard, in some embodiments.

Although the exemplary network environment 200 with the CFAED 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the CFAED 202, the server devices 204(1)-204(n), or the client devices 208(1)-208(n), in some embodiments, may be configured to operate as virtual instances on the same physical machine. In some embodiments, one or more of the CFAED 202, the server devices 204(1)-204(n), or the client devices 208(1)-208(n) may operate on the same physical device rather than as separate devices communicating through communication network(s) 210.

Additionally, there may be more or fewer CFAEDs 202, server devices 204(1)-204(n), or client devices 208(1)-208(n) than illustrated in FIG. 2. In some embodiments, the CFAED 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

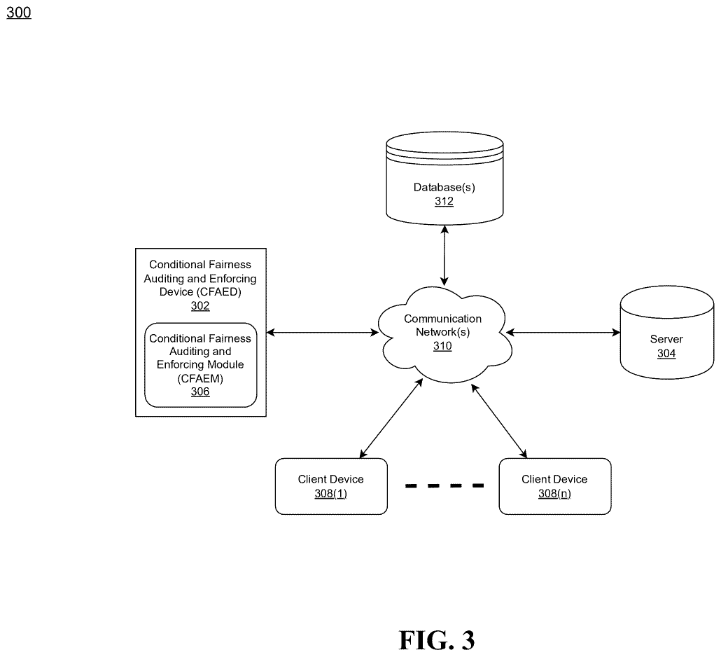

FIG. 3 illustrates a system diagram for implementing a platform, language, and cloud agnostic CFAED having a platform, language, database, and cloud agnostic conditional fairness auditing and enforcing module (CFAEM) in accordance with an embodiment.

As illustrated in FIG. 3, the system 300 may include an CFAED 302 within which an CFAEM 306 may be embedded, a server 304, a database(s) 312, a plurality of client devices 308(1) . . . 308(n), and a communication network 310.

In some embodiments, the CFAED 302 including the CFAEM 306 may be connected to the server 304, and the database(s) 312 via the communication network 310. The CFAED 302 may also be connected to the plurality of client devices 308(1) . . . 308(n) via the communication network 310, but the disclosure is not limited thereto.

According to exemplary embodiment, the CFAED 302 is described and shown in FIG. 3 as including the CFAEM 306, although it may include other rules, policies, modules, databases, or applications, etc. In some embodiments, the database(s) 312 may be configured to store ready to use modules written for each Application Programming Interface (API) for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto. In addition, the database(s) 312 may store input data that relates to a person, and wherein the decision relates to at least one from among a consumer finance question, a health insurance question, and a hiring question; the first feature that may include at least one from among race, gender, national origin, and disability; and the second feature that may include one from among a level of education, a grade point average, and a level of income, but the disclosure is not limited thereto.

In some embodiments, the CFAEM 306 may be configured to receive real-time feed of data from the plurality of client devices 308(1) . . . 308(n) and secondary sources via the communication network 310.

As may be described below, the CFAEM 306 may be configured to: identify at least one feature associated with data that is inputted into the machine learning model; determine a first joint distribution of outputs from the machine learning model and a second feature from among the at least one feature based on a first level of a first feature from among the at least one feature and a second joint distribution of outputs from the machine learning model and the second feature based on a second level of the first feature; calculate corresponding conditional demographic disparity between the first joint distribution and the second joint distribution with respect to both the first feature and the second feature and with respect to both the first level and the second level; aggregate each conditional demographic disparity into a single conditional demographic disparity value; audit the conditional fairness by computing a distance between the first joint distribution and the second joint distribution based on the single conditional demographic disparity value; compute, based on the distance, a regularizer that reduces the conditional demographic disparity; and enforce the conditional fairness by applying the regularizer to the machine learning model, thereby substantially improving performance of the machine learning model in outputting results, but the disclosure is not limited thereto. For example, the features values may represent other data as disclosed above.

The plurality of client devices 308(1) . . . 308(n) are illustrated as being in communication with the CFAED 302. In this regard, the plurality of client devices 308(1) . . . 308(n) may be “clients” (e.g., customers) of the CFAED 302 and are described herein as such. Nevertheless, it is to be known and understood that the plurality of client devices 308(1) . . . 308(n) need not necessarily be “clients” of the CFAED 302, or any entity described in association therewith herein. Any additional or alternative relationship may exist between either or both of the plurality of client devices 308(1) . . . 308(n) and the CFAED 302, or no relationship may exist.

The first client device 308(1) may be, in some embodiments, a smart phone. Of course, the first client device 308(1) may be any additional device described herein. The second client device 308(n) may be, in some embodiments, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. In an embodiment, one or more of the plurality of client devices 308(1) . . . 308(n) may communicate with the CFAED 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The CFAED 302 may be the same or similar to the CFAED 202 as described with respect to FIG. 2, including any features or combination of features described with respect thereto.

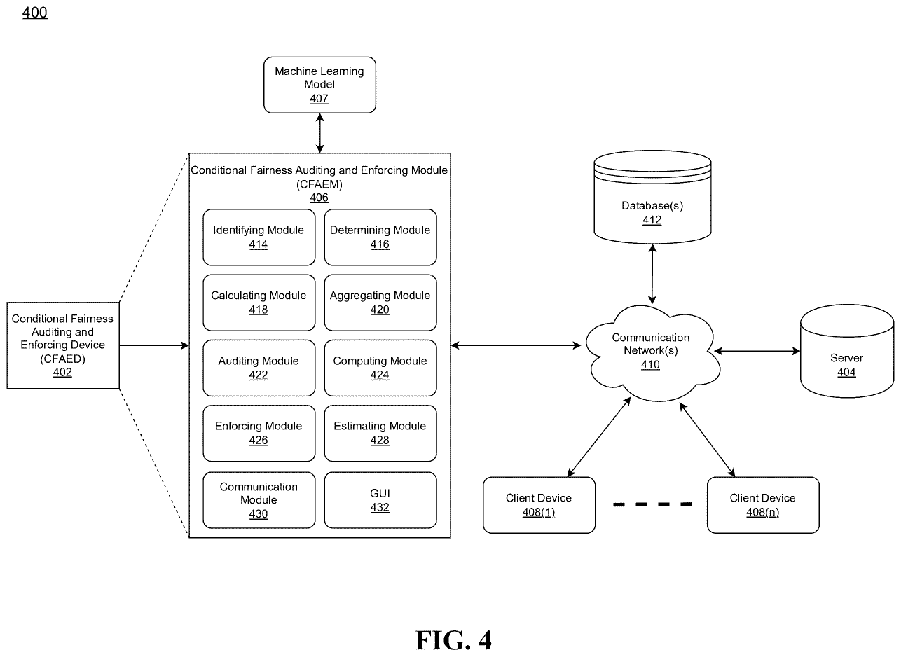

FIG. 4 illustrates a system diagram for implementing a platform, language, database, and cloud agnostic CFAEM of FIG. 3 in accordance with an exemplary embodiment.

In some embodiments, the system 400 may include a platform, language, database, and cloud agnostic CFAED 402 within which a platform, language, database, and cloud agnostic CFAEM 406 may be embedded, a server 404, a machine learning model 407, database(s) 412, and a communication network 410. In some embodiments, server 404 may comprise a plurality of servers located centrally or located in different locations, but the disclosure is not limited thereto.

In some embodiments, the CFAED 402 including the CFAEM 406 may be connected to the server 404, the machine learning model 407, and the database(s) 412 via the communication network 410. The CFAED 402 may also be connected to the plurality of client devices 408(1)-408(n) via the communication network 410, but the disclosure is not limited thereto. The CFAEM 406, the server 404, the plurality of client devices 408(1)-408(n), the database(s) 412, the communication network 410 as illustrated in FIG. 4 may be the same or similar to the CFAEM 306, the server 304, the plurality of client devices 308(1)-308(n), the database(s) 312, the communication network 310, respectively, as illustrated in FIG. 3.

In some embodiments, as illustrated in FIG. 4, the CFAEM 406 may include an identifying module 414, a determining module 416, a calculating module 418, an aggregating module 420, an auditing module 422, a computing module 424, an enforcing module 426, an estimating module 428, a communication module 430, and a Graphical User Interface (GUI) 432. In some embodiments, interactions and data exchange among these modules included in the CFAEM 406 provide the advantageous effects of the disclosed invention. Functionalities of each module of FIG. 4 may be described in detail below with reference to FIGS. 4-8.

In some embodiments, each of the identifying module 414, determining module 416, calculating module 418, aggregating module 420, auditing module 422, computing module 424, enforcing module 426, estimating module 428, and the communication module 430 of the CFAEM 406 of FIG. 4 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

In some embodiments, each of the identifying module 414, determining module 416, calculating module 418, aggregating module 420, auditing module 422, computing module 424, enforcing module 426, estimating module 428, and the communication module 430 of the CFAEM 406 of FIG. 4 may be implemented by microprocessors or similar, and may be programmed using software (e.g., microcode) to perform various functions discussed herein and may optionally be driven by firmware and/or software.

Alternatively, in some embodiments, each of the identifying module 414, determining module 416, calculating module 418, aggregating module 420, auditing module 422, computing module 424, enforcing module 426, estimating module 428, and the communication module 430 of FIG. 4 may be implemented by dedicated hardware, or as a combination of dedicated hardware to perform some functions and a processor (e.g., one or more programmed microprocessors and associated circuitry) to perform other functions, but the disclosure is not limited thereto. In some embodiments, the CFAEM 406 of FIG. 4 may also be implemented by cloud-based deployment.

In some embodiments, each of the identifying module 414, determining module 416, calculating module 418, aggregating module 420, auditing module 422, computing module 424, enforcing module 426, estimating module 428, and the communication module 430 the CFAEM 406 of FIG. 4 may be called via corresponding API, but the disclosure is not limited thereto. For example, in some embodiments, the identifying module 414 may be called via a first API, the determining module 416 may be called via a second API, the calculating module 418 may be called via a third API, the aggregating module 420 may be called via a fourth API, the auditing module 422 may be called via a fifth API, the computing module 424 may be called via a sixth API, the enforcing module 426 may be called via a seventh API, the estimating module 428 may be called via an eight API, and the communication module 430 may be called via a ninth API. In some embodiments, calls may also be made using event-based message interfaces in addition to APIs. An event-based message interface may be a design pattern that enables communication between services by defining events and handlers that process them. This approach may allow for efficient communication and decoupled components, which may lead to more flexible and modular systems.

In some embodiments, the process implemented by the CFAEM 406 may be executed via the communication module 430, and the communication network 410, which may comprise plural networks as described above. In some embodiments, in an exemplary embodiment, the various components of the CFAEM 406 may communicate with the server 404, and the database(s) 412 via the communication module 430 and the communication network 410 and the results may be displayed onto the GUI 432. Of course, these embodiments are merely exemplary and are not limiting or exhaustive. The database(s) 412 may include the databases included within the private cloud and/or public cloud and the server 404 may include one or more servers within the private cloud and the public cloud.

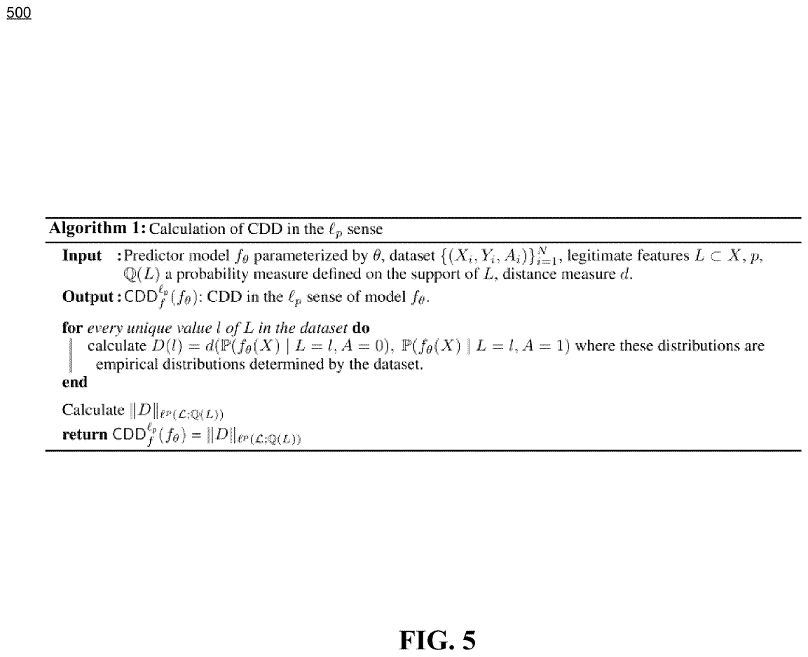

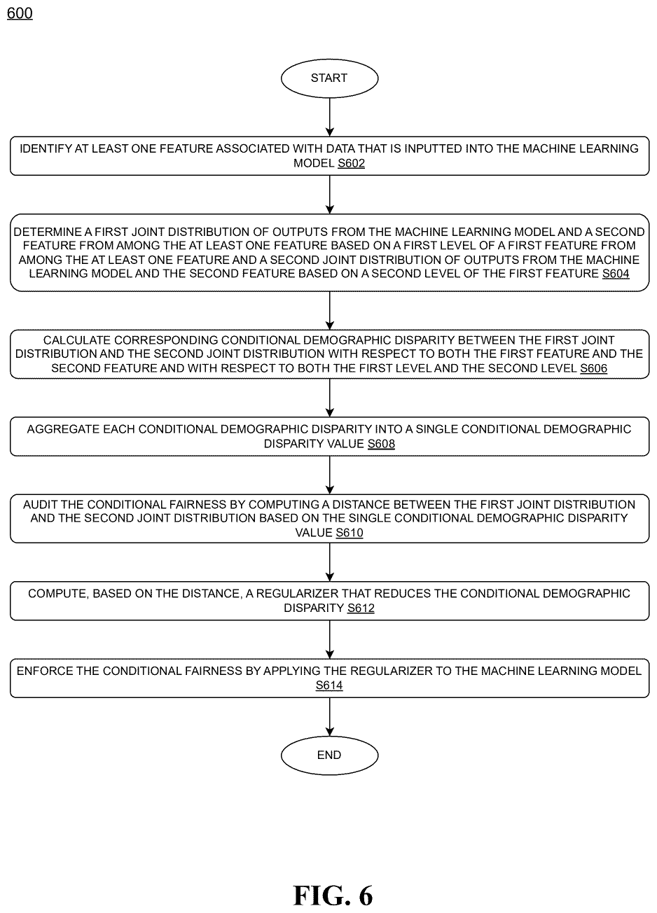

FIG. 5 illustrates an algorithm 500 implemented by the CFAEM 406 of FIG. 4 for auditing and enforcing conditional fairness in accordance with an embodiment. FIG. 6 illustrates a flow chart of a process 600 implemented by the CFAEM 406 of FIG. 4 for implementing artificial intelligence and machine learning models and techniques to audit and enforce conditional fairness via optimal transport in accordance with an embodiment. It may be appreciated that the illustrated process 600 and associated steps may be performed in a different order, with illustrated steps omitted, with additional steps added, or with a combination of reordered, combined, omitted, or additional steps.

Referring to FIGS. 4-6, in some embodiments, at step S602, the process 600 may include identifying, by calling the identifying module 414 (see FIG. 4) via a first API, at least one feature associated with data that is inputted into the machine learning model.

In some embodiments, at step S604, the process 600 may include determining, by calling the determining module 416 via the second API, a first joint distribution of outputs from the machine learning model 407 and a second feature from among the at least one feature based on a first level of a first feature from among the at least one feature and a second joint distribution of outputs from the machine learning model 407 and the second feature based on a second level of the first feature.

In some embodiments, the machine learning model 407 may be configured to use an artificial intelligence technique for making a decision based on input data that relates to a person, and wherein the decision may relate to at least one from among a consumer finance question, a health insurance question, and a hiring question, but the disclosure is not limited thereto. In some embodiments, the first feature may include at least one from among race, gender, national origin, and disability, but the disclosure is not limited thereto. In some embodiments, the second feature may include one from among a level of education, a grade point average, and a level of income, but the disclosure is not limited thereto. In some embodiments, the machine learning model 407 may include one or more of the following models: decision tree, ensemble trees, logistic regression, neural network architectures, and predictive model, but the disclosure is not limited thereto.

As mentioned earlier, conventional techniques may be configured to target demographic parity (DP), but not conditional demographic parity (CDP). One method to target CDP may be to stratify on the legitimate feature (i.e., the first feature as discussed above) and apply methods designed to achieve DP within each stratum. However, this may result in poor overall model performance, especially if there is a small amount of data in each level. The process 600 implemented by the CFAEM 406 of FIG. 4 may be configured to utilize the entire dataset during model training. Additionally, the majority of conventional methods for DP may be designed for classification or only designed to equalize the first moments of the two distributions, whereas process 600 implemented by the CFAEM 406 of FIG. 4 may target full conditional independence in both classification and regression settings.

For example, conventional techniques discussed above may accommodate rich legitimate features and continuous outcomes and may also involve a regularizer applied to the entire dataset. However, this conventional regularizer may be equivalent to a proxy quantity that may be distinct from the disparity of interest. Small values of the proxy quantity may not necessarily imply small values of the disparity. By contrast, the CFAEM 406 of FIG. 4 may be configured to utilize regularizers that directly target the distances between the relevant conditional distributions. Additionally, conventional techniques may require access to a sensitive feature, e.g., the average loan amount for males versus females, at inference time. However, the methods implemented by the CFAEM 406 of FIG. 4 may not require access to the sensitive feature at inference time, thereby improving the model outputs of the machine learning model 407.

Moreover, conventional algorithmic fairness method may consider classification settings in which the final model outputs are binary. These conventional methods may handle continuous outputs only to equalize the first moments of the output distributions across levels of the sensitive feature (e.g., the average loan amount for males versus females). In contrast, the process 600 implemented by the CFAEM 406 of FIG. 4 may ensure equality of conditional output distributions across levels of the legitimate feature, regardless of whether the output is discrete or continuous.

For example, in some embodiments, at step S606, the process 600 implemented by the CFAEM 406 of FIG. 4 may include, calculating, by calling the calculating module 418 via the third API, corresponding conditional demographic disparity (CDD) between the first joint distribution and the second joint distribution with respect to both the first feature and the second feature and with respect to both the first level and the second level.

In some embodiments, at step S608, the process 600 implemented by the CFAEM 406 of FIG. 4 may include aggregating, by calling the aggregating module 420 via the fourth API, each CDD into a single conditional demographic disparity value.

For example, in some embodiments, the process 600 implemented by the CFAEM 406 of FIG. 4 may consider data drawn from a distribution (X, A, Y)~ [symbol] , where X∈ [symbol] is a set of features, A∈{0,1} is a binary sensitive feature, and Y∈ [symbol] is a prediction target. The process 600 may utilize “ [symbol] ” to denote statistical independence, and utilize P to refer both to the probability measure and to its density, assuming the density is defined. For example, let f: [symbol] → [symbol] be a model (i.e., machine learning model 407 as illustrated in FIG. 4) whose (un)fairness may be measured by the CFAEM 406. In practice, f(X) might map to a prediction that may be utilized downstream in some decision process, or it might map to an automated decision such as a loan approval decision. Everything that follows applies in either setting.

Definition 1.1 (Demographic parity (DP)). The model f(X) satisfies demographic parity (DP) if f(X) [symbol] A, or in other words [symbol] (f(X)|A=0)≡ [symbol] (f(X)|A=1). DP may take into consideration only the sensitive feature and model outputs; it may be indifferent to the features X. That is a model which satisfies DP may treat different groups differently within levels of X, which may result in intuitively unfair behavior. To address this issue, the process 600 implemented by the CFAEM 406 may consider Conditional Demographic Parity (CDP) as an alternative.

Definition 1.2 (CDP). The model f(X) satisfies conditional demographic parity with respect to a feature or set of features ⊂ X if f(X) [symbol] A|L=1, for all l∈supp [symbol] (L|A=0)∩supp [symbol] (L|A=1), where L corresponds to the legitimate feature(s) discussed earlier. In the loan approval example, L would be the income level. The choice of L, and the choice of the sensitive feature A, may be depended on the user.

In this disclosure, it may be assumed that supp [symbol] (L|A=0)=supp [symbol] (L|A=1), i.e. the legitimate features have the same support for both groups represented by the sensitive feature. Since any method targeting CDP requires multiple samples at each level of L, it may be further assumed that L is either naturally discrete or appropriately discretized.

In some embodiments, the process 600 implemented the CFAEM 406 may be configured to effectively promote CDP in supervised learning problems. A crucial step towards enforcing parity may be to choose an appropriate disparity measure which is discussed below.

### Measuring Disparities

Quantifying violations of parity may indicate the development of fairness methods disclosed herein, and may allow the fairness of different models and methods to be compared on a continuous scale. Any definition of the CDD, the violation of CDP, may take into account the conditional distributions for each possible level/of the legitimate features, as well as how to aggregate these level-wise features to output a single CDD value.

For example, at step S606, the process 600 may utilize any measure of demographic disparity (the violation of DP) to measure violations at each level 1. In conventional techniques, the DP may be represented by

$$\vert 𝔼 \vert f ( X ) \vert A = 1 ] - 𝔼 [ f ( X ) \vert A = 0 ] \vert or by 𝔼 ( f ( X ) \vert A = 1 ] / 𝔼 ( f ( X ) \vert A = 0 ] ,$$

considering only the first moments of the distributions. However, at step 606, the process 600 may consider distances between the full conditional distributions. For example, the process 600 implemented by the CFAEM 406 may implement the CDD in the [symbol] ^{p} sense. Here, “ [symbol] ^{p}” and “Wasserstein” refer to the aggregation method implemented at step S606 once the level-wise distances between the conditional distributions are obtained.

For any p∈[1, ∞), let [symbol] ₚ(⋅,⋅; D), at step S606, the process 600 implemented by the CFAEM 406 may denote the p-Wasserstein distance with cost function D, so that

$${𝒲}_{p}^{p}$$

denotes [symbol] ₚ taken to the power p. The Wasserstein distance represents the smallest possible cost to transport all the probability mass from one distribution to another given cost function D.

### Definition 2.1 (CDD in the lp Sense)

Let d (⋅,⋅) denote a distance between distributions, let p∈[1, ∞), and let [symbol] be the support of L.

$$Define D : ℒ ↦ ℝ as$$

$$D ( l ) = d ( ℙ ( f ( X ) \vert L = l , A = 0 ) , ℙ ( f ( X ) \vert L = l , A = 1 ) ) .$$

The conditional demographic disparity in the [symbol] ₚ sense (CD [symbol] ) of the model f(X) is CD [symbol] (f):=∥D [symbol] where [symbol] (L) is a probability measure defined over [symbol] .

The disparity in Definition 2.1 is the weighted [symbol] ₚ norm of the distances between the conditional distributions defined by levels l of the legitimate features, where the associated measure [symbol] determines the weight assigned to each level.

In some embodiments, at step S610, the process 600 implemented by the CFAEM 406 may include auditing, by calling the auditing module 422 (see FIG. 4) via the fifth API, the conditional fairness by computing a distance between the first joint distribution and the second joint distribution based on the single CDD value described in definition 2.1 above. At step S612, the process 600 implemented by the CFAEM 406 may include computing, based on the distance, a regularizer that reduces the CDD by calling the computing module 424 via the sixth API.

In the regularizer computed at step S612, the CFAEM 406 may set d to be the Wasserstein distance for both definitions, and may fix p=1 for CD [symbol] and compute with respect to several versions of [symbol] (L) for CD [symbol] . See, for example, see algorithm 1 of calculation of CDD in the [symbol] ₚ sense as illustrated in algorithm 500 in FIG. 5.

### Regularized Approaches to Enforce CDP

In some embodiments, at step S614, the process 600 implemented by the CFAEM 406 may include enforcing, by calling the enforcing module 426 via the seventh API, the conditional fairness by applying the regularizer to the machine learning model 407, thereby substantially improving performance of the machine learning model 407 in outputting results. In light of the discussion above with respect to auditing the CDP, a natural approach to enforce CDP in risk minimization problems may be to employ the CDD measures in Definition 2.1 as regularizers. In particular, given an i.i.d. training sample

$${\{ ( {X}_{i} , {Y}_{i} , {A}_{i} ) \}}_{i = 1}^{N} ,$$

the CFAEM 406 may consider the following target problem:

$${min}_{{f}_{θ} ∈ ℱ} \frac{1}{N} {{\sum }_{i = 1}}^{N} g ( {f}_{θ} ( {X}_{i} ) , {Y}_{i} ) + λ CDD ( {f}_{θ} ) , \qquad ( 1 )$$

where g is a differentiable loss function, F={f_{θ}:θ∈Θ} is the class of models f_{θ}(X) under consideration, indexed by θ, λ>0 is a penalty parameter to encourage fairness, and CDD represents CD [symbol] .
Enforcing CDD in the [symbol] ₚ Sense

The regularization term CDD(f_{θ}) in this case may take the form CD [symbol] (f_{θ})=∥D [symbol] as described in Definition 2.1 above. The method based on CD [symbol] may be referred to herein as FairLeap: Conditional Fairness in the [symbol] p sense (see, e.g., algorithm 1 as illustrated in algorithm 500 in FIG. 5). The parameters p (the order of the [symbol] p norm) and [symbol] (L) (the probability measure over [symbol] ) determine how the level-wise disparities are aggregated. The process 600 implemented by the ACFEM 406 may implement the following three aggregation strategies, which result in three variants of FairLeap:

Fairleap (uniform): A simple average with [symbol] = [symbol] (L), which we use from here forward to denote the uniform distribution over L: This puts equal emphasis on every observed level of L.

Fairleap ( [symbol] (L)): A weighted average with [symbol] = [symbol] (L) and p=1: This prioritizes levels of L with more mass.

Fairleap (Ave. [symbol] (L|A)): A weighted average with

$$ℚ = \frac{ℙ ( L \vert A = 0 ) + ℙ ( L \vert A = 1 )}{2} and p = 1 :$$

This may prioritize levels of L with more mass, within either class of A, and may avoid favoring the majority class.

In some embodiments, the unknown distribution [symbol] may be replaced with the empirical distribution. A main advantage of these choices of p and [symbol] may be that they yield interpretable regularizers. In terms of the inner distance function d, the definition of CDD^{l}^{ₚ} may be generic and may admit any distributional distance. In the process 600 implemented by the ACFEM 406, may including utilizing Wasserstein distance due to the known connection between closeness of distribution in Wasserstein sense and parity of performance in downstream tasks, the ACFEM 406 may estimate the Wasserstein distance by employing a divergence algorithm, which may be differentiable and may be represented as

$$𝒪 ( \frac{{n}^{2}}{\vert L \vert} ) ,$$

where |L|≤n is the number of levels of L observed in the sample.

In some embodiments, the CFAED 402 may include a memory (e.g., a memory 106 as illustrated in FIG. 1) which may be a non-transitory computer readable medium that may be configured to store instructions for implementing a platform, language, database, and cloud agnostic CFAEM 406 for implementing artificial intelligence and machine learning models and techniques to audit and enforce conditional fairness via optimal transport regardless of whether conditioning variable has many levels and validate efficacy of the implemented algorithms on real-world datasets as disclosed herein. The CFAED 402 may also include a medium reader (e.g., a medium reader 112 as illustrated in FIG. 1) which may be configured to read any one or more sets of instructions, e.g., software, from any of the memories described herein. The instructions, when executed by a processor embedded within the CFAEM 406 or within the CFAED 402, may be used to perform one or more of the processes as described herein. In a particular embodiment, the instructions may reside completely, or at least partially, within the memory 106, the medium reader 112, and/or the processor 104 (see FIG. 1) during execution by the CFAED 402.

In some embodiments, the instructions, when executed, may cause a processor embedded within the CFAEM 406 or the CFAED 402 to perform the following: identifying at least one feature associated with data that is inputted into the machine learning model; determining a first joint distribution of outputs from the machine learning model and a second feature from among the at least one feature based on a first level of a first feature from among the at least one feature and a second joint distribution of outputs from the machine learning model and the second feature based on a second level of the first feature; calculating corresponding conditional demographic disparity between the first joint distribution and the second joint distribution with respect to both the first feature and the second feature and with respect to both the first level and the second level; aggregating each conditional demographic disparity into a single conditional demographic disparity value; auditing the conditional fairness by computing a distance between the first joint distribution and the second joint distribution based on the single conditional demographic disparity value; computing, based on the distance, a regularizer that reduces the conditional demographic disparity; and enforcing the conditional fairness by applying the regularizer to the machine learning model, thereby substantially improving performance of the machine learning model in outputting results, but the disclosure is not limited thereto. For example, the features values may represent other data as disclosed above. In some embodiments, the processor may be the same or similar to the processor 104 as illustrated in FIG. 1 or the processor embedded within the CFAED 202, CFAED 302, CFAED 402, and CFAEM 406 which may be the same or similar to the processor 104.

In some embodiments, in enforcing the conditional fairness, the instructions, when executed, may cause the processor 104 to further perform the following: computing a weighted average value of the calculated corresponding conditional demographic disparity.

In some embodiments according to the non-transitory computer readable medium, the machine learning model may be configured to use an artificial intelligence technique for making a decision based on input data that relates to a person, and wherein the decision relates to at least one from among a consumer finance question, a health insurance question, and a hiring question, but the disclosure is not limited thereto.

In some embodiments according to the non-transitory computer readable medium, the first feature may include at least one from among race, gender, national origin, and disability, but the disclosure is not limited thereto.

In some embodiments according to the non-transitory computer readable medium, the second feature may include one from among a level of education, a grade point average, and a level of income, but the disclosure is not limited thereto.

In some embodiments according to the non-transitory computer readable medium, the machine learning model may include one or more of the following models: decision tree, ensemble trees, logistic regression, neural network architectures, and predictive model, but the disclosure is not limited thereto.

In some embodiments as disclosed above in FIGS. 1-6, technical improvements effected by the instant disclosure may include a platform for implementing a platform, language, database, and cloud agnostic conditional fairness auditing and enforcing module configured to implement artificial intelligence and machine learning models and techniques to audit and enforce conditional fairness via optimal transport regardless of whether conditioning variable has many levels and validate efficacy of the implemented algorithms on real-world datasets, but the disclosure is not limited thereto.

Although the invention has been described with reference to several exemplary embodiments, it is understood that the words that have been used may be words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, method, and uses such as are within the scope of the appended claims.

In some embodiments, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards may be periodically superseded by faster or more efficient equivalents having essentially the same functions. Accordingly, replacement standards and protocols having the same or similar functions may be considered equivalents thereof.

The illustrations of the embodiments described herein are intended to provide a general understanding of the various embodiments. The illustrations are not intended to serve as a complete description of all of the elements and features of apparatus and systems that utilize the structures or method described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for auditing and enforcing conditional fairness in a machine learning model by utilizing one or more processors along with allocated memory, the method comprising:
identifying at least one feature associated with data that is inputted into the machine learning model;
determining a first joint distribution of outputs from the machine learning model and a second feature from among the at least one feature based on a first level of a first feature from among the at least one feature and a second joint distribution of outputs from the machine learning model and the second feature based on a second level of the first feature;
calculating corresponding conditional demographic disparity between the first joint distribution and the second joint distribution with respect to both the first feature and the second feature and with respect to both the first level and the second level;
aggregating each conditional demographic disparity into a single conditional demographic disparity value;
auditing the conditional fairness by computing a distance between the first joint distribution and the second joint distribution based on the single conditional demographic disparity value;
computing, based on the distance, a regularizer that reduces the conditional demographic disparity; and
enforcing the conditional fairness by applying the regularizer to the machine learning model, thereby substantially improving performance of the machine learning model in outputting results.

2. The method of claim 1, wherein in enforcing the conditional fairness, the method further comprising:
computing a weighted average value of the calculated corresponding conditional demographic disparity.

3. The method of claim 1, wherein the machine learning model is configured to use an artificial intelligence technique for making a decision based on input data that relates to a person.

4. The method of claim 3, wherein the decision relates to at least one from among a consumer finance question, a health insurance question, and a hiring question.

5. The method of claim 1, wherein the first feature includes at least one from among race, gender, national origin, and disability.

6. The method of claim 1, wherein the second feature includes one from among a level of education, a grade point average, and a level of income.

7. A system for auditing and enforcing conditional fairness in a machine learning model, the system comprising:
a processor; and
a memory operatively connected to the processor via a communication interface, the memory storing computer readable instructions, when executed, causes the processor to:
identify at least one feature associated with data that is inputted into the machine learning model;
determine a first joint distribution of outputs from the machine learning model and a second feature from among the at least one feature based on a first level of a first feature from among the at least one feature and a second joint distribution of outputs from the machine learning model and the second feature based on a second level of the first feature;
calculate corresponding conditional demographic disparity between the first joint distribution and the second joint distribution with respect to both the first feature and the second feature and with respect to both the first level and the second level;
aggregate each conditional demographic disparity into a single conditional demographic disparity value;
audit the conditional fairness by computing a distance between the first joint distribution and the second joint distribution based on the single conditional demographic disparity value;
compute, based on the distance, a regularizer that reduces the conditional demographic disparity; and
enforce the conditional fairness by applying the regularizer to the machine learning model, thereby substantially improving performance of the machine learning model in outputting results.

8. The system of claim 7, wherein in enforcing the conditional fairness, the processor is further configured to:
compute a weighted average value of the calculated corresponding conditional demographic disparity.

9. The system of claim 7, wherein the machine learning model is configured to use an artificial intelligence technique for making a decision based on input data that relates to a person.

10. The system of claim 9, wherein the decision relates to at least one from among a consumer finance question, a health insurance question, and a hiring question.

11. The system of claim 7, wherein the first feature includes at least one from among race, gender, national origin, and disability.

12. The system of claim 7, wherein the second feature includes one from among a level of education, a grade point average, and a level of income.

13. A non-transitory computer readable medium configured to store instructions for auditing and enforcing conditional fairness in a machine learning model, the instructions, when executed, cause a processor to perform the following:
identifying at least one feature associated with data that is inputted into the machine learning model;
determining a first joint distribution of outputs from the machine learning model and a second feature from among the at least one feature based on a first level of a first feature from among the at least one feature and a second joint distribution of outputs from the machine learning model and the second feature based on a second level of the first feature;
calculating corresponding conditional demographic disparity between the first joint distribution and the second joint distribution with respect to both the first feature and the second feature and with respect to both the first level and the second level;
aggregating each conditional demographic disparity into a single conditional demographic disparity value;
auditing the conditional fairness by computing a distance between the first joint distribution and the second joint distribution based on the single conditional demographic disparity value;
computing, based on the distance, a regularizer that reduces the conditional demographic disparity; and
enforcing the conditional fairness by applying the regularizer to the machine learning model, thereby substantially improving performance of the machine learning model in outputting results.

14. The non-transitory computer readable medium of claim 13, wherein in enforcing the conditional fairness, the instructions, when executed, cause the processor to further perform the following:
computing a weighted average value of the calculated corresponding conditional demographic disparity.

15. The non-transitory computer readable medium of claim 13, wherein the machine learning model is configured to use an artificial intelligence technique for making a decision based on input data that relates to a person.

16. The non-transitory computer readable medium of claim 15, wherein the decision relates to at least one from among a consumer finance question, a health insurance question, and a hiring question.

17. The non-transitory computer readable medium of claim 13, wherein the first feature includes at least one from among race, gender, national origin, and disability.

18. The non-transitory computer readable medium of claim 13, wherein the second feature includes one from among a level of education, a grade point average, and a level of income.
